(19) United States
(12) Patent Application Publication
(10) Pub. No.: US 2009/0068870 A1
(43) Pub. Date: Mar. 12, 2009

(54) FLOATING SELF-CENTERING CONNECTOR

(76) Inventor: Victor B. Mezhinsky, Brea, CA (US)

Correspondence Address: ALCON, IP LEGAL, TB4-8, 6201 SOUTH FREEWAY, FORT WORTH, TX, 76134, US

(21) Appl. No.: 12/188,909

(22) Filed: Aug. 8, 2008

Related U.S. Application Data
(60) Provisional application No. 60/954,735, filed on Aug. 8, 2007.

(51) Int. Cl. H01R 13/642; B23P 11/00; G02B 6/36

(52) U.S. Cl. 439/247; 29/428; 385/53

(57) ABSTRACT

A self-centering connection is provided. This self-centering connection includes a first substrate, a first connector assembly, a first number of alignment guides, a second substrate, a second connector assembly, a second number of alignment guides, and a number of free-floating compression fastener systems. The first connecting assembly is mounted on the first substrate. The first alignment guides are amounted on both the first and second substrate. The second connector assembly is mounted on the second substrate. The free-floating compression fastener system mechanically couples the first substrate to the second substrate wherein tolerances of the free-floating compression fastener system allow the first substrate to float relative to the second substrate in an XY in a first plane. The compression load of the compression fastener system allows the first substrate to float in a Z axis relative to the second substrate.

### CROSS-REFERENCE TO RELATED APPLICATIONS

The present U.S. Utility patent application claims priority pursuant to 35 U.S.C. § 119(e) to the following U.S. Provisional Patent Application which is hereby incorporated herein by reference in its entirety and made part of the present U.S. Utility patent application for all purposes:

1. U.S. Provisional Application Ser. No. 60/954,735, entitled “FLOATING SELF-CENTERING CONNECTOR,” (Attorney Docket No. 3313 Pr), filed Aug. 8, 2007.

### TECHNICAL FIELD OF THE INVENTION

The present invention relates generally to electronic connectors. More particularly, the present invention relates to a method and apparatus for mounting a printed circuit board assembly, having a blind mate connector, to a supporting structure in a floating configuration.

### BACKGROUND OF THE INVENTION

Prior art printed circuit board assemblies (“PCBAs”) having a blind mate connector are typically rigidly mounted onto a supporting substrate, such as a sheet metal panel or a bracket. A reliable blind mate connector alignment and eventual connection are not guaranteed due to parts manufacturing tolerances and misalignment between the connector male and female components.

Some connectors are designed to bend to a certain extent to compensate for a misalignment. However, in some cases, the bending of the connectors may not be sufficient for compensating a misalignment. In other cases, although a misalignment may be compensated by the bending, an intensive use will likely result in a shortened connector lifetime.

Therefore, a need exists for a floating, self-centering connector and method of using same that allows a PCBA to move along three axis of movement within the allowable clearance between the PCBA mounting holes and fastening hardware, thus overcoming the prior art problems of connector misalignment and excessive stress on the connector, while ensuring a proper electrical connection.

### SUMMARY OF THE INVENTION

Embodiments of the present invention substantially address the above identified needs and others. One object of the present invention is to provide a simple, self-centering floating connector and a floating mounting method for a PCBA that allows the PCBA to move along X, Y and Z axes within an allowable tolerance between a PCBA mounting hole and a fastening hardware, to ensure proper connector alignment and electrical connection.

Embodiments of the method and apparatus of the present invention may be implemented within any electronic system or device in which it is advantageous to have a secure, simple and self-centering floating connector that allows a PCBA, and the connector mounted onto the PCBA, to float along X, Y and Z axes, thus eliminating connector male and female component misalignment. In particular, the embodiments of the present invention can be used within an electronic assembly for a laser device.

In one embodiment, a self-centering connection is provided. This self-centering connection includes a first substrate, a first connector assembly, a first number of alignment guides, a second substrate, a second connector assembly, a second number of alignment guides, and a number of free-floating compression fastener systems. The first connecting assembly is mounted on the first substrate. The first alignment guides are amounted on both the first and second substrate. The second connector assembly is mounted on the second substrate. The free-floating compression fastener system mechanically couples the first substrate to the second substrate wherein tolerances of the free-floating compression fastener system allow the first substrate to float relative to the second substrate in an XY in a first plane. The compression load of the compression fastener system allows the first substrate to float in a Z axis relative to the second substrate.

In another embodiment, a self-centering connection is provided. This self-centering connection includes a printed circuit board assembly, a first connector assembly, a first number of alignment guides, an equipment chassis, a second connector assembly, a second number of alignment guides, and a number of free-floating compression fastener systems. The first connecting assembly is mounted on the printed circuit board assembly. The first alignment guides are mounted on both the printed circuit board assembly and equipment chassis. The second connector assembly is mounted on the equipment chassis. The free-floating compression fastener system mechanically couples the printed circuit board assembly to the equipment chassis wherein tolerances of the free-floating compression fastener system allow the printed circuit board assembly to float relative to the equipment chassis in an XY in a first plane. The compression load of the compression fastener system allows the printed circuit board assembly to float in a Z axis relative to the equipment chassis.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 depicts an embodiment of an engaged blind mate connector in accordance with embodiments of the present invention;

FIG. 2A provides a cross-section of a first sub-straight being a printed circuit board assembly mounted to a chassis using a free-floating compression fastener system in accordance with embodiment for the present invention.

FIG. 2B provides a top-down view showing a printed circuit board assembly mounted to an equipment chassis using a free-floating compression fastener system in accordance with embodiment for the present invention.

FIG. 3 depicts an isometric view of a laser module in accordance with embodiments of the present invention;

FIG. 4 depicts an isometric view of another embodiment of a floating PCBA in accordance with embodiments of the present invention within a laser implementation;

FIG. 5 depicts another isometric view of another embodiment of a floating PCBA in accordance with embodiments of the present invention within a laser implementation; and

FIG. 6 provides a logic flow diagram of a method of forming a connection in accordance with embodiments of the present intention

### DETAILED DESCRIPTION OF THE INVENTION

Preferred embodiments of the present invention are illustrated in the FIGs., like numerals being used to refer to like and corresponding parts of the various drawings.

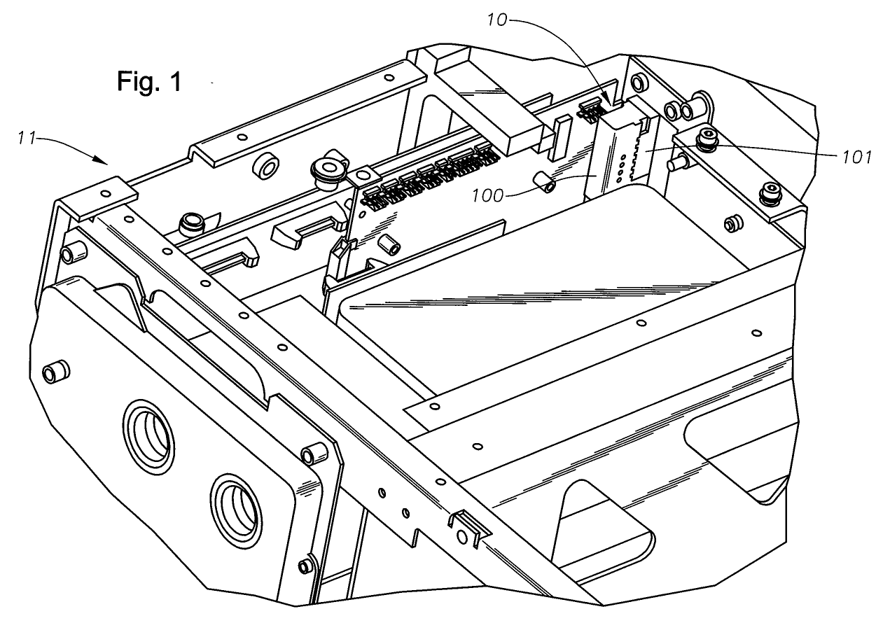

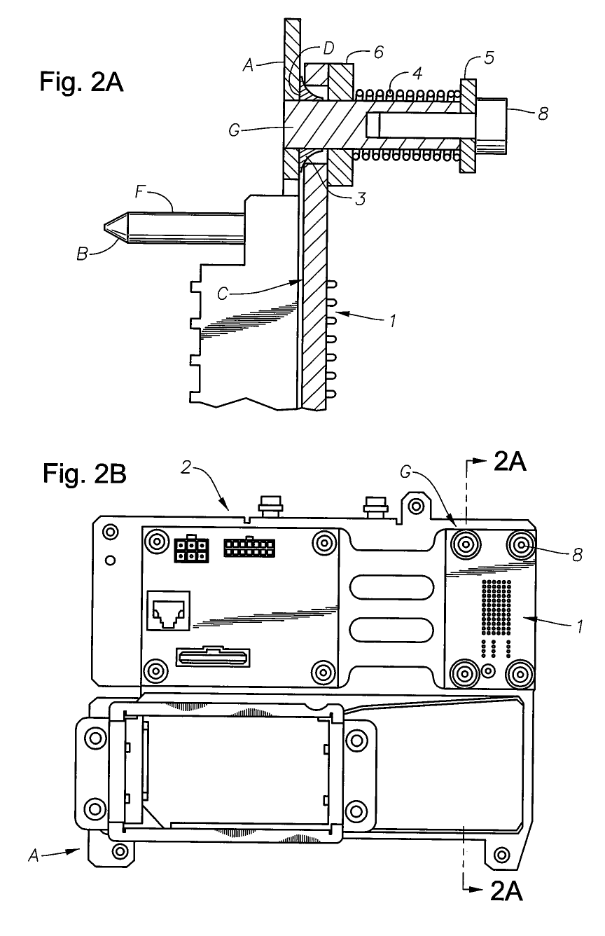

FIG. 1 depicts an embodiment of an engaged blind mate connector 10, in accordance with the present invention, within a laser assembly. The laser side portion 100 of the connector 10 (female in this example) has two alignment holes that cooperate and engage with the PCBA portion 101 of the connector 10. The PCBA portion 101 has two alignment pins adapted to cooperate with the alignment holes of the laser side portion 100, as is more clearly shown in FIGS. 2A and 2B, section A-A.

FIG. 2A provides a cross-section of a first sub-straight being a printed circuit board assembly mounted to a chassis using a free-floating compression fastener system in accordance with embodiment for the present invention. FIG. 2B provides a top-down view showing a printed circuit board assembly mounted to an equipment chassis using a free-floating compression fastener system in accordance with embodiment for the present invention. As shown in FIGS. 2A and 2B, PCBA 1 can be mounted onto bracket A of, in this example, a ducting assembly 2 by means of socket head cup screws (“SHCS”) 8 or similar fasteners, flat washers 5, compression springs 4 and other flat washers 6, or other such fastening assemblies as will be known to those having ordinary skill in the art. Cross-section A-A depicts these parts in a sectional view. The fasteners can be coupled to standoffs G that support the floating PCBA 1.

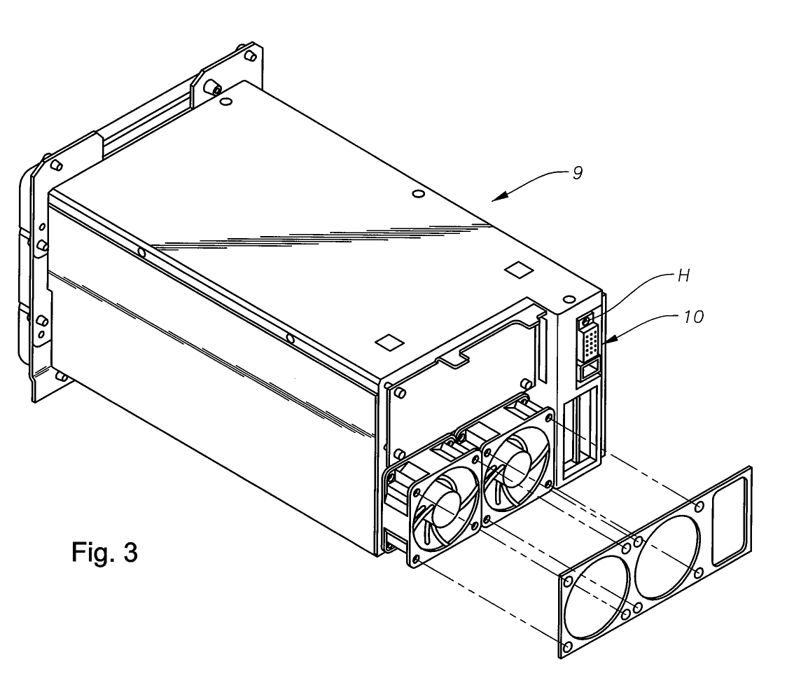

FIG. 3 depicts an isometric view of a laser module 9, with the rear side of the laser housing facing forward. The female portion 100 of the blind mate connector 10 has two alignment holes H, one on each side of the electrical contact sockets. Alignment pins F, as shown in FIGS. 2A and 2B of the PCBA portion 101 of the connector 10 cooperate and fit within holes H to properly align the two portions of connector 10.

A tapered washer 3, as shown in FIG. 2A, is adapted to separate the back surface C of PCBA 1 and the mounting plate A. Under a no load condition (when the blind connector 10 portions are not engaged with their mating part), the back surface C of the PCBA 1 rests on the tapered washer 3 flat surface D, and the tapered portion of tapered washer 3 protrudes inside of the PCBA mounting clearance hole E. Tapered washer 3 is adapted to and acts to center the PCBA 1, for example, during installation of a laser into laser module 9.

The position of the female portion 100 of blind mate connector 10 (e.g., in the example of FIG. 3 it is part of laser module 9) is adapted such that upon the installation of a laser in the chassis of module 9 the alignment holes H of the female portion 100 engage with the pins F of the male (PCBA) portion 101 of connector 10. The pins F have a taper tip B that, in this example, allows for a slight amount, e.g., about +/−0.050″, of connector misalignment.

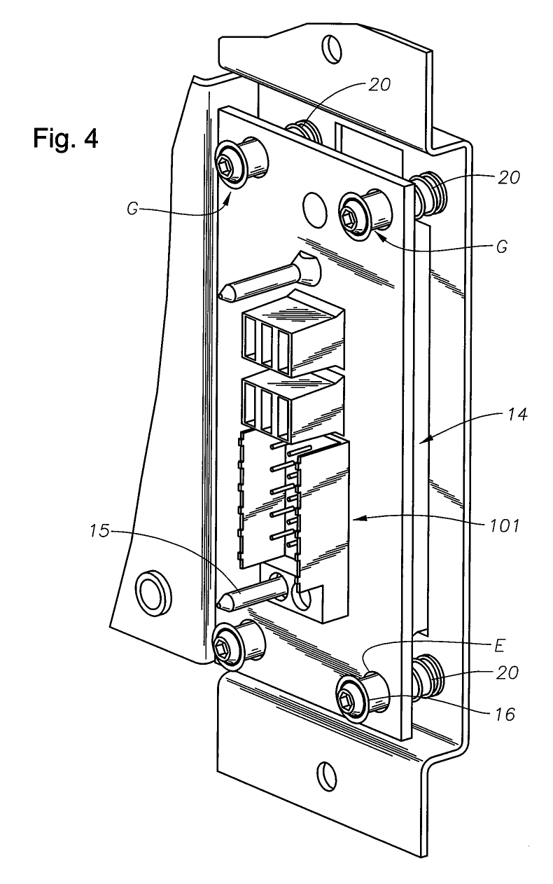

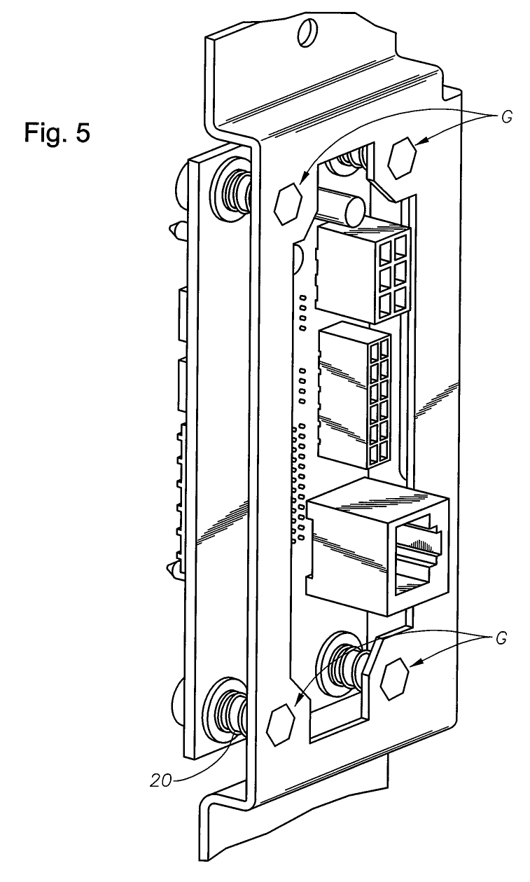

FIGS. 4 and 5 depict isometric views of another embodiment of a floating PCBA 14 comprising a connector male portion 101 in accordance with the present invention within a laser implementation. Embodiments of the apparatus of this invention allow PCBA 14 to float along X, Y and Z axes. The X and Y axes float is provided by the relatively large clearance between the outside diameter of the 4 studs (e.g., studs G of FIGS. 2A and 2B) and the inner diameter of the 4 holes (e.g., holes E of FIGS. 2A and 2B) in the PCBA 14. Before engagement with the mating (e.g. female portion 100) connector, the PCBA 14 and male connector portion 101 are positioned such that centering studs 15 are centered in X and Y axes by the springs 20 pushing the PCBA 14 against cone-shaped washers 16 at the ends of studs G. During engagement, alignment to the mating connector portion 100 is controlled by pin and hole features incorporated into the connector 10.

Compliance in the Z axis direction is provided by the PCBA 14 sliding down the length of the studs G, as shown in FIGS. 4 and 5. Springs 20 bias the PCBA 14 to a fully extended position for the earliest engagement. Even in the fully extended position, the combined spring force of the springs 20 is greater than the insertion force of the mating connector 10 portions. Additionally, the center of load for the connector 10 insertion force is located, preferably, equally between the studs G and springs 20 so that the springs are equally loaded and the PCBA 14 retracts without excessive tilting.

Returning to FIGS. 2A and 2B, in an exemplary operation for a laser module installation implementing an embodiment of the present invention, when a laser module 9 is being installed into chassis 11 of FIG. 1, the laser module 9 progresses to a fully installed position in the chassis 11 and the female portion 100 (operably coupled to module 9) of connector 10 pushes the male PCBA portion 101 linearly to the rear (away from the PCBA 1 supporting structure A), thus disengaging the tapered washer 3 and the back surface C of the PCBA 1 and compressing the springs 4 (20). During this time, the connector 10 engagement forces act radially upon the PCBA 1 and the PCBA 1 may float in the X and Y axes directions within the clearance between the hole E inner diameter and the standoff G outer diameter, while being restrained in the Z axis direction by the mounting screws 8.

The embodiments of the present invention provide various advantages over the prior art. Proper engagement of blind connector 10 is ensured by the embodiments of the apparatus and method of this invention in that they provide for a PCBA, and a connector 10 mounted on the PCBA, to float in the X, Y and Z axes directions, thus eliminating the effect of excessive misalignment between the connector 10 portions. Further, in the case of the floating portion of a connector 10, the embodiments of this invention allow for floating of the PCBA, which may be more advantageous in certain implementations, such that movement in the X, Y and Z axes directions may be customized to suit a user and implementation.

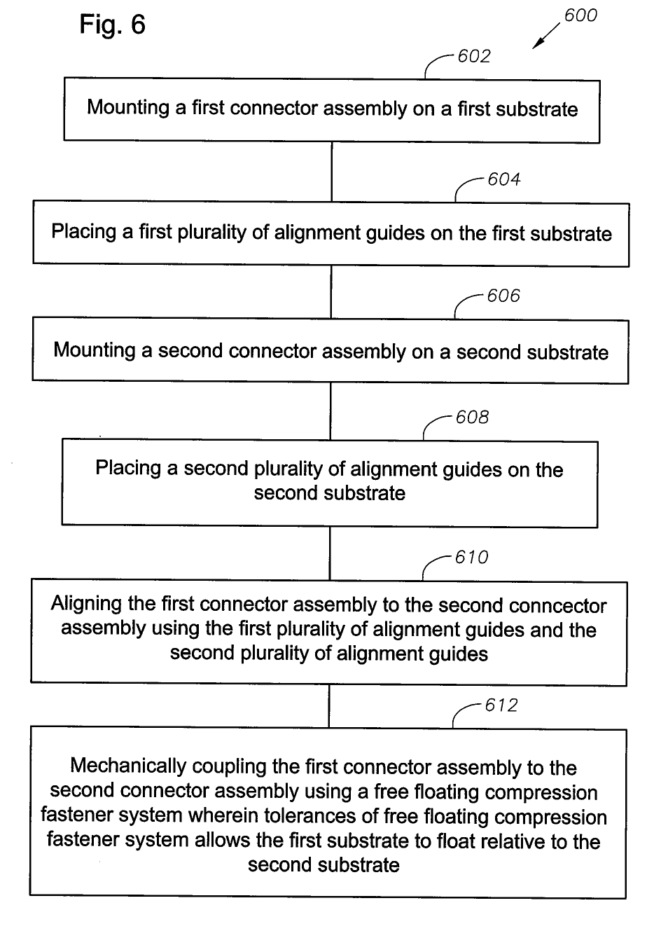

FIG. 6 provides a logic flow diagram of a method of forming a connection in accordance with embodiments of the present intention. Operations 600 begin with Step 602 when a first connector assembly is mounted on a first substrate. In Step 604, a number of alignment guides are mounted on the first substrate as well. In Step 606, a second connector assembly is mounted on a second substrate. In Step 608 alignments guides are mounted on the second substrate as well. In Step 610 the first connector assembly is aligned to the second connector assembly using the alignment guides mounted to the first substrate and the second substrate. Then in Step 612 the first connector assembly is mechanically coupled to the second connector assembly using a free floating compression fastener system. Tolerances of the free floating compression fastener system allow the first substrate to float relative to the second substrate in three dimensions.

The free-floating compression fastener system may include alignment pins, alignment holes, a compression-loaded male fastener having a shoulder, a female fastener operable to mechanically couple to the compression-loaded male fastener as shown with reference to FIGS. 2A and 2B. The alignment holes have an inner diameter greater than that of the alignment pin. The shoulder of the compression-loaded male fastener pushes against a substrate in which the alignment hole is located. The difference between the alignment hole diameter, hole pin.

In summary, a self-centering connection is provided. This self-centering connection includes a first substrate, a first connector assembly, a first number of alignment guides, a second substrate, a second connector assembly, a second number of alignment guides, and a number of free-floating compression fastener systems. The first connecting assembly is mounted on the first substrate. The first alignment guides are amounted on both the first and second substrate. The second connector assembly is mounted on the second substrate. The free-floating compression fastener system mechanically couples the first substrate to the second substrate wherein tolerances of the free-floating compression fastener system allow the first substrate to float relative to the second substrate in an XY in a first plane. The compression load of the compression fastener system allows the first substrate to float in a Z axis relative to the second substrate. This connection may be an optical, acoustic, electrical or fluid type connection.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

Although the present invention is described in detail, it should be understood that various changes, substitutions and alterations can be made hereto without departing from the spirit and scope of the invention as described by the appended claims.

What is claimed is:

1. A self centering connection, comprising:
a first substrate;
a first connector assembly, the first connector assembly mounted on the first substrate;
a first plurality of alignment guides on the first substrate;
a second substrate;
a second connector assembly, the second connector assembly coupled to a second substrate;
a second plurality of alignment guides on the second substrate;
a second connector assembly; and
a plurality of free floating compression fastener systems operable to mechanically couple the first substrate and the second substrate, wherein tolerances of the free floating compression fastener systems allow the first substrate to float relative to the second substrate.

2. The self centering connection of claim 1, wherein the free floating compression fastener systems comprise:
alignment pins;
alignment holes have a diameter greater than a diameter of the alignment pin;
a compression loaded male fastener having a shoulder, the shoulder operable to push against a substrate in which the alignment hole is located; and
a female fastener operable to mechanically couple to the compression loaded male fastener,
a difference between the alignment hole diameter and the alignment pin diameter allows the alignment pin to float within a plane of the alignment hole, and the compression load of the male fastener allows the alignment pin to float along a longitudinal axis of the alignment pin and relative to the alignment hole.

3. The self centering connection of claim 1, wherein the first substrate comprises a printed circuit board assembly.

4. The self centering connection of claim 1, wherein the second substrate comprises a chassis to which the first substrate is mounted.

5. The self centering connection of claim 1, wherein the first connector and the second connector assembly comprise an electrical connection.

6. The self centering connection of claim 1, wherein the first connector and the second connector assembly comprise an optical connection.

7. The self centering connection of claim 1, wherein the first connector and the second connector assembly comprise a fluid connection.

8. A method comprising:
mounting a first connector assembly on a first substrate;
placing a first plurality of alignment guides on the first substrate;
mounting a second connector assembly on a second substrate;
placing a second plurality of alignment guides on the second substrate;
aligning the first connector assembly to the second connector assembly using the first plurality of alignment guides and the second plurality of alignment guides;
mechanically coupling the first connector assembly to the second connector assembly using free floating compression fastener systems wherein tolerances of the free floating compression fastener systems allow the first substrate to float relative to the second substrate.

9. The method of claim 8, wherein the free floating compression fastener systems comprise:
alignment pins;
alignment holes have a diameter greater than a diameter of the alignment pin;
a compression loaded male fastener having a shoulder, the shoulder operable to push against a substrate in which the alignment hole is located; and
a female fastener operable to mechanically couple to the compression loaded male fastener,
a difference between the alignment hole diameter and the alignment pin diameter allows the alignment pin to float within a plane of the alignment hole, and the compression load of the male fastener allows the alignment pin to float along a longitudinal axis of the alignment pin and relative to the alignment hole.

10. The method of claim 8, wherein the first substrate comprises a printed circuit board assembly.

11. The method of claim 8, wherein the second substrate comprises a chassis to which the first substrate is mounted.

12. The method of claim 8, wherein the first connector and the second connector assembly comprise an electrical connection.

13. The method of claim 8, wherein the first connector and the second connector assembly comprise an optical connection.

14. The method of claim 8, wherein the first connector and the second connector assembly comprise a fluid connection.

15. A self centering connection, comprising:
a printed circuit board assembly;
a first connector assembly, the first connector assembly mounted on the printed circuit board assembly;
a first plurality of alignment guides on the printed circuit board assembly;
an equipment chassis;
a second connector assembly, the second connector assembly coupled to the equipment chassis;
a second plurality of alignment guides on the second substrate; and
a plurality of free floating compression fastener systems operable to mechanically couple the printed circuit board assembly and the equipment chassis, wherein tolerances of the free floating compression fastener systems allow the printed circuit board assembly to float relative to the equipment chassis.

16. The self centering connection of claim 15, wherein the free floating compression fastener systems comprise:
alignment pins;
alignment holes have a diameter greater than a diameter of the alignment pin;
a compression loaded male fastener having a shoulder, the shoulder operable to push against a substrate in which the alignment hole is located; and
a female fastener operable to mechanically couple to the compression loaded male fastener,
a difference between the alignment hole diameter and the alignment pin diameter allows the alignment pin to float within a plane of the alignment hole, and the compression load of the male fastener allows the alignment pin to float along a longitudinal axis of the alignment pin and relative to the alignment hole.

17. The self centering connection of claim 15, wherein the first connector and the second connector assembly comprise an electrical connection.

18. The self centering connection of claim 15, wherein the first connector and the second connector assembly comprise an optical connection.

19. The self centering connection of claim 15, wherein the first connector and the second connector assembly comprise a fluid connection.

20. The self centering connection of claim 15, wherein the printed circuit board assembly supports a laser system.
